(19) United States
(12) Patent Application Publication
(10) Pub. No.: US 2009/0283289 A1
(43) Pub. Date: Nov. 19, 2009

(54) WEDGE RETENTION ASSEMBLY

(75) Inventors: Bryan Casenhiser, Twinsburg, OH (US); Christopher Mook, Twinsburg, OH (US)

Correspondence Address: TUROCY & WATSON, LLP, 127 Public Square, 57th Floor, Key Tower, CLEVELAND, OH, 44114, US

(73) Assignee: PREFORMED LINE PRODUCTS COMPANY, Mayfield Village, OH (US)

(21) Appl. No.: 12/120,818

(22) Filed: May 15, 2008

(51) Int. Cl. H02G 7/20

(52) U.S. Cl. 174/43; 174/45 R

(57) ABSTRACT

A cable wedge assembly that can streamline installation of cabling assemblies upon trees and other structures is provided. For example, the cable wedge assembly need not require specialized tools for installation. Rather, the unique features and functions of the assembly attach to a cable merely by inserting a cable through the assembly, tightening a portion of the connector upon another and establishing tension in the cable. Once cable tension is established, the integral wedges seat causing attachment to and retention of the cable. This attachment and retention is effected by way of split conical inserts disposed within the housing of the assembly.

### BACKGROUND

Oftentimes it is necessary to secure a cable into a trunk, branch or limb of a tree (or other similar structure). There are two methods frequently used to cable trees, ‘static’ and ‘dynamic’ cabling. The type of support system used depends on tree age, species, and on the structure and condition of the tree that needs support. Static cabling involves the use of steel cable and eye-bolts that are drilled directly into the tree. Dynamic cabling often employs the use of synthetic, rope-like cable that is wrapped around the stem. In dynamic cabling installations, the rope-like cable is capable of expanding with changes in the diameter of the tree.

Generally, the process of installing a steel wire, rope, steel strand or synthetic-fiber system with a tree between limbs or leaders to limit movement and provide supplemental support is often referred to as ‘rigging,’ ‘cabling,’ ‘bracing,’ or ‘guying.’ Standards and techniques for these support systems are defined by the American National Standards Institute (ANSI) in specification A300, part 3. Often, these cabling systems are installed upon historic trees or storm damaged trees to provide more stability.

Each of the two traditional methods has pros and cons. For example, some of the pros associated with static cabling are that 1) static cabling has a positive history of success, 2) the materials last long even in extreme environmental conditions, and 3) larger limbs can be supported. Some of the cons associated with static cabling are 1) they require drilling into the tree, which causes wounding, 2) special tools are usually required, and 3) the system is rigid in that the tree cannot move on its own which has been proven to make weak branches even weaker once cabled.

Similar to the static systems, dynamic systems have pros and cons. For instance, some pros associated with dynamic systems are 1) there is no wounding (e.g., drilling) of the tree, 2) the systems are lightweight and easy to install, and 3) the tree is able to move in the wind, increasing the strength of the stem and branches. Unfortunately, these pros do not come without cons. Some of the cons of dynamic cabling include, 1) the cables may stretch over time, 2) the materials can be affected by photo-degradation, and 3) the breaking strength of the materials is less.

All too often trees develop weak or poor structure, requiring special care to preserve them and prevent further injury. Even trees that are routinely maintained may develop weaknesses that affect their own safety and that of people and property. The most common problem is the weak attachment that may occur when two or more branches of about equal size arise at approximately the same level on the trunk. Similarly, horizontal branches can become heavy and dangerous, leaving them more vulnerable to weakening by decay and storms. Although proper pruning can shorten, lighten and thin hazardous branches, in some cases, this may be inadequate to keep certain limbs or trees safe. Thus, cabling and bracing may be required to reduce stress.

Unfortunately, conventional devices (e.g., hardware) or schemes used to attach cables to trees, poles, etc., have undesirable drawbacks and limitations. For instance, installation is sometimes cumbersome as specialized hardware and tools are most often necessary. Still further, conventional rigging schemes require additional hardware inventory which adds to the expense of the cabling process.

In addition to the drawbacks of conventional systems, the ability to employ rigging cabling techniques can be restricted due to physical constraints. In other words, the ability to employ conventional rigging schemes may not be possible due to physical placement of the tree(s), for example, due to the relative placement of the tree in relation to other trees or structures. As well, conventional systems may not be available due to physical limitations of the branches or limbs upon the tree.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a cable wedge assembly that can streamline installation of cabling assemblies. For example, the cable wedge assembly of the innovation need not require specialized tools for installation. Rather, the unique features and functions of the innovation enable the assembly to be attached to a cable merely by inserting a cable through the assembly, tightening a portion of the connector upon another, and establishing tension in the cable. Once cable tension is established, the integral wedges seat causing attachment to and retention of the cable.

Effectively, the unique split conical insert disposed within an outer housing can retain a cable under tension. More particularly, in one aspect, internal threads and a wedging action can be employed to firmly retain steel guy strand cable or steel rods. A retaining cap can be used to keep the wedge assembly in place during assembly onto the guy wire as well as after the wedges have seated into the housing.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates perspective view of an example tree wedge assembly in accordance with an aspect of the innovation.

FIG. 2 illustrates an exploded view of an example tree wedge assembly in accordance with an aspect of the innovation.

FIG. 3 illustrates an exemplary flow chart of procedures that facilitate cabling in accordance with an aspect of the innovation.

FIG. 4 illustrates various example views of a tree wedge assembly housing in accordance with an aspect of the innovation.

FIG. 5 illustrates various example views of wedges that can be employed within the tree wedge assembly of the innovation.

FIG. 6 illustrates various example views of a tree wedge assembly cap in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

As described above, in the practice of arboriculture, preventive maintenance and repair measures for trees often involves the use of cabling. The field of cabling is often categorized into ‘static’ and ‘dynamic’ cabling. Static cabling refers to implementations where a hole is drilled into a tree, for example, to insert a lag hook. On the other hand, dynamic cabling employs wrapping techniques rather than actually inserting hardware (or cabling) into the tree.

In some conventional static cabling implementations, threaded fasteners are used to form anchor sites for the installation of a flexible cable between a tree trunk and a tree branch or between multiple branches of a tree. As will be understood, cabling installed between branches can limit excessive branch motion and to reduce stress on a crotch formed by the branches as well as upon the branches themselves. The cabling may extend from a tree (or a branch thereof) to an adjacent tree or to the ground to provide support for the branch or trunk of the tree. As well, cabling techniques can be employed to secure the tree to another stationary structure such as a pole or a building.

More commonly, however, the arboriculture procedures involve connecting two dominant branches of a forked tree so that each of the two dominant branches will support the other branch. Particularly, in the case of forked trees, cabling can effectively prevent or reduce splitting due to environmental conditions such as wind, ice, etc. or the weight of a dominant branch itself.

In conventional systems, a lag hook is a fastener commonly used in the cabling trees. In operation, a pilot hole is drilled into the tree. Thereafter, the lag hook, having an elongated threaded shank, can be driven into the wood of the tree. When drilling the pilot hole, a drill bit with a diameter about ⅛ inch less than the pitch diameter of the threads on the shank of the lag hook is selected. This selection (e.g., ⅛ inch or less) can minimize stresses in both the lag hook and the wood of the tree.

Continuing with a description of a conventional static cabling technique, the threaded shank of the lag hook terminates at a short linear shank having a smooth and slightly larger diameter than the outside diameter of the threads on the shank, for example, forming a ‘lip’ or a ridge. Most often, this shank, or at least part of the short linear shank, is advanced into the wood of the tree by tightening the threads in an effort to experience the benefit of the added strength of the short shank. Additionally, the short shank can seal the entrance to the threads of the threaded shank, thereby protecting the threads from environmental conditions.

Upon installing the lag hook, the installer can use a ‘lag spinner’ or other suitable specialized tool. In other examples a wrench or even a screwdriver can be used to leverage the curved end of the lag hook in order to thread the hook into the pilot hole. Nevertheless, this process requires some tools whether specialized or common hand tools. Additionally, because the installer is often suspended in a safety harness attached to one or more safety ropes, installation using tools can be increasing difficult.

Unlike conventional static installations, the innovation need not require specialized tools. As well, hand tools need not be used to install the tree wedge assembly of the innovation. Rather, the unique wedge shaped insert of the innovation is capable of gripping the cable merely as a function of design. Thus, lag bolts or the like are not needed to effect cabling installation in accordance with the innovation.

Unlike traditional products, the innovation is capable of holding 100% of the Rated Breaking Strength of a strand. Additionally, some traditional products require strands to be separated and threaded through a center hole of the device and thereafter bent to retain the strand. Thus, these traditional devices employ ‘sandwiching’ techniques to derive compression. In other words, compression is derived from ‘sandwiching’ some of the strands between an insert and the housing. In accordance with the innovation disclosed and claimed herein, a wedge insert is employed to create or generate the load. The features, functions and benefits of this wedge-based load generation will be better understood upon a review of the figures that follow.

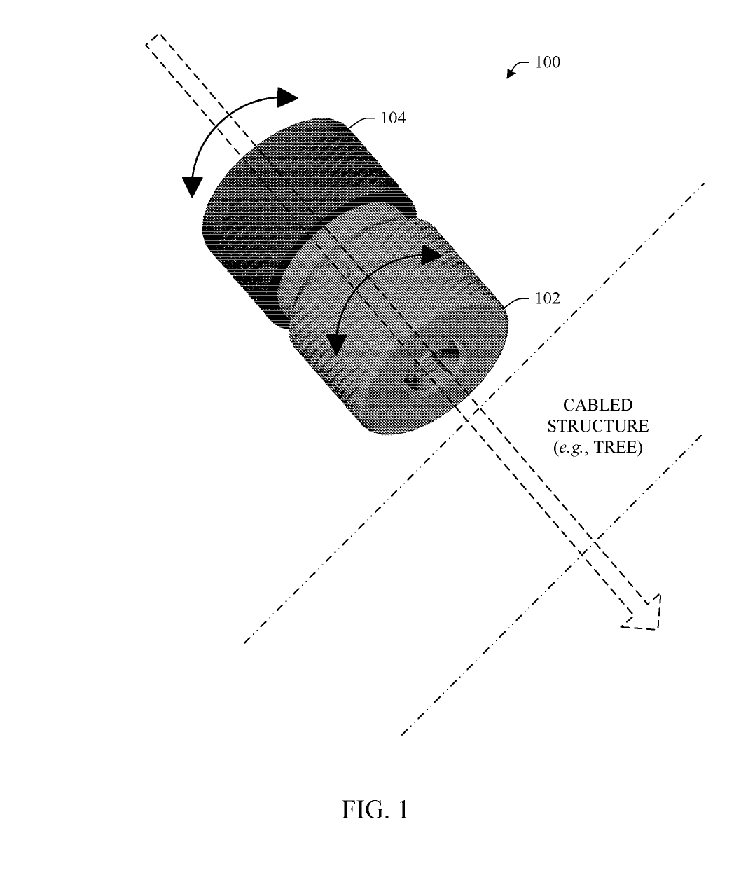

Referring initially to the drawings, FIG. 1 illustrates a perspective view of a tree wedge assembly 100 in accordance with an aspect of the innovation. Generally, the tree wedge assembly 100 of FIG. 1 can include a housing 102 and a cap 104, having a split wedge block(s) (not shown) disposed within the housing. Each of these components will be described with reference to the figures that follow.

Essentially, the tree wedge assembly 100 of FIG. 1 performs as a stop to retain a cable. As illustrated, the assembly 100 can be used to prevent a cable from pulling through a tree, for example, when used in tree rigging or bracing. In operation, a hole can be drilled through a tree limb or branch (or other structure, e.g., pole). As shown, the cable strand would be terminated on the outside face of the tree with the tree wedge assembly 100. As the weight of the tree halves pull apart, the wedges would seat into the housing to prevent the strand (or rod) from pulling out of the assembly 100.

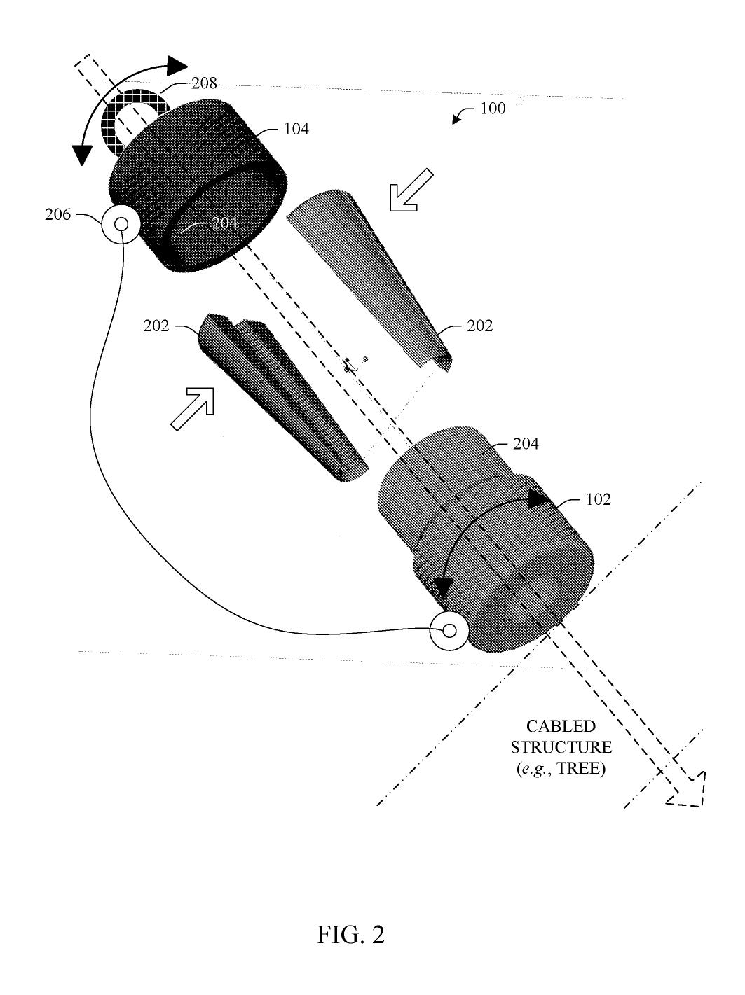

Turning now to FIG. 2, an exploded perspective view of an example tree wedge assembly 100 is shown. As illustrated, the tree wedge assembly 100 can include split wedge blocks 202 which can be integrally positioned within the housing 102 and cap 104. As will be understood, the cable (or rod) can be fed through the cap 104 and housing 102. As illustrated, the housing 102 can be equipped with a threaded portion 204 which communicatively mates with a threaded portion 102 on the inner surface of the cap 104.

In operation, the housing 102 can be threaded into the cap 104. As the cap 104 is threaded (or tightened) onto the threaded portion of the housing (102), the split wedge halves 202 can compress around the cable (or rod). As shown, the inner portion of the split wedge halves 202 can be equipped with grooves (or other friction generation surface) which can enhance the gripping action of the assembly 100 to the cable or rod. Additionally, while a threaded connection between the housing 102 and cap 104 is shown, it is to be understood that other suitable mechanical arrangements can be employed to connect the two units.

As shown in FIG. 2, the housing 102 and cap 104 can be equipped with an optional tether or strap assembly 206 which connects the units (102, 104). It will be understood that this optional assembly 206 can assist during installation by ensuring that one of the units (102, 104) is not dropped or separated from the other during installation. While a specific tether assembly 206 and placement thereof is illustrated in FIG. 2, it is to be understood that most any arrangement and/or placement can be used without departing from the spirit and/or scope of the innovation. For example, rather than employing rings to attach a tether, alternative aspects can employ holes in either or both the cap 104 or housing 102.

In yet other aspects, an optional connection loop 208 (or other suitable connection means 208) can be positioned upon the cap assembly 104 to enable connection of a tether or support. While a looped connection means 208 is illustrated in FIG. 2, it is to be understood that alternative connection means (e.g., j-shaped hooks, eye-bolts etc.), can be employed without departing from the spirit and/or scope of the innovation and claims appended hereto. Although the optional connection means 208 is illustrated with an attachment point on the cap assembly 104, it is to be understood that an optional connection means 208 can also be deployed or positioned upon the housing 102 without departing from the spirit and/or scope of the innovation.

While specific shapes of components and surfaces are illustrated in FIG. 2, it is to be appreciated that alternative aspects can employ other shapes, diameters and/or surfaces as appropriate or desired. For example, although the exterior of the housing 102 and cap 104 are substantially round in shape, it is to be understood that other aspects can employ other configurations, for example, hexagon such that a standard wrench could be used to torque the housing to the cap if appropriate or desired. Additionally, although the example shown and described herein employs two wedges 202, it is to be understood that other aspects can employ a single compressible wedge assembly, three wedge assemblies or the like without departing from the spirit and/or scope of the innovation and claims appended hereto. These alternative aspects are to be included within the scope of this disclosure and claims appended hereto.

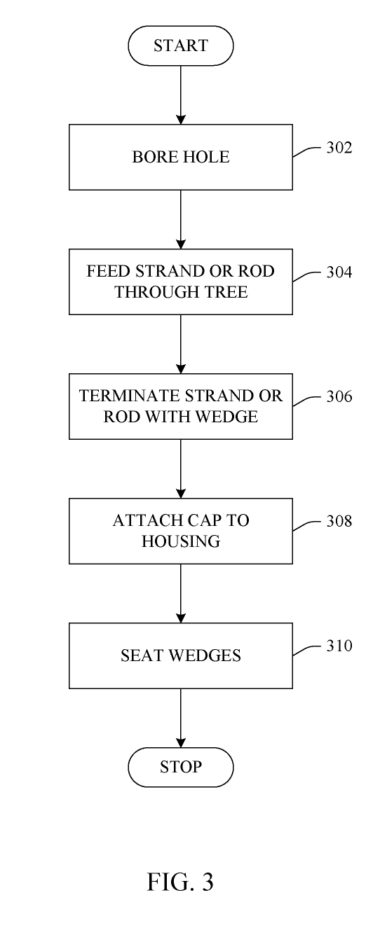

FIG. 3 illustrates a methodology of securing a cable or brace in accordance with an aspect of the innovation. Although the methodology of FIG. 3 describes a methodology of bracing a tree, it is to be understood that the methodology can be applied to most any structure (e.g., pole) without departing from the spirit and scope of the innovation described and claimed herein. Additionally, most any cable, rod or support material can be employed without departing from wedge retention aspects of the innovation.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. Moreover, not all illustrated acts may be required to implement a methodology in accordance with the innovation.

As described herein, in aspects, the innovation can employ internal threads and a wedging action to firmly hold onto a steel guy strand, metal rod, etc. For example, when bracing a tree that has been split down the middle or a tree with a forked trunk, the innovation would typically be employed by an arborist or in the agriculture industry. However, it is to be understood that other applications of the innovation exist that are to be included within the scope of this disclosure and claims appended hereto.

At 302, a hole is bore into a tree. Here, a hole can be drilled completely through a tree. For example, in the case of a tree that has been split due to environmental conditions (e.g., lightening), the both halves of the tree can be drilled in order to bore a hole completely through the tree.

At 304, a metal (e.g., steel) strand cable or other metal rod or support can be fed through the hole. On each of the outside faces of the tree, the strands are terminated at 306. More particularly, in aspects, a tree wedge assembly (e.g., 100 of FIG. 1) can be used to terminate the support (e.g., cable) on the outside of the tree. In this example, the cap is attached to the housing at 308. As shown in FIGS. 1 and 2, the two components can be threaded together (or tightened) causing the wedges to engage the cable.

As the weight of the tree halves pull apart, the wedges seat at 310. For example, as illustrated in FIG. 2, the wedges would seat into the housing to prevent the strand or rod from pulling out of the tree wedge assembly. In other words, as the tree wedge assemblies are attached to the cable on the outside(s) of the tree, they perform as stoppers to retain the cable or rod, thereby effecting desired bracing or support for the tree.

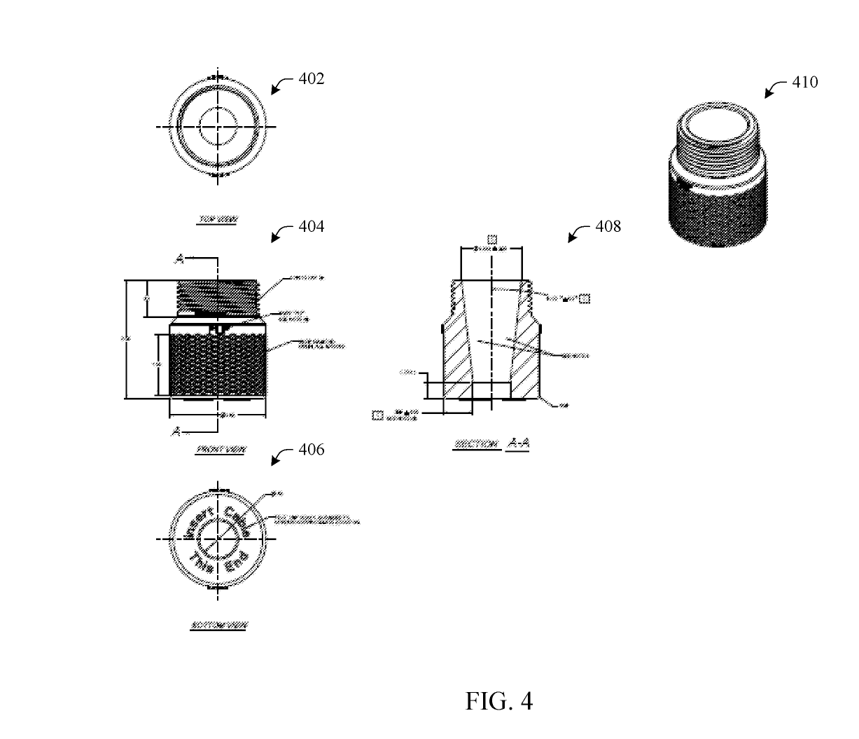

One benefit of the tree wedge assembly of FIGS. 1 and 2 over conventional products is the use of the retaining cap. This retaining cap can hold the wedges in place during assembly on the guy wire (or other support) as well as after the wedges have seated themselves due to the tension. Other benefits of the innovation will be appreciated by those skilled in the art, for example, lower inventory, efficiency of installation procedures, fewer (if any) tools required for installation, etc. FIGS. 4, 5 and 6 that follow illustrate detailed examples of a housing (102), wedges (202) and cap (104) respectively. It is to be understood that these are illustrated examples and that other alternative components exist without departing from the spirit and/or scope of the innovation. For example, sizes, shapes, materials, configurations, number of components (e.g., wedges), may vary in other aspects. These alternative aspects are to be included within the scope of this disclosure and claims appended hereto without departing from the features, functions and benefits described herein.

Referring first to FIG. 4, five views of an example housing 102 are shown. More specifically, FIG. 4 illustrates a top view, front view, bottom view, cross-sectional view and perspective view of an example housing in accordance with an aspect of the innovation. As stated above, the examples illustrated are included to add perspective to the innovation and are not intended to limit the innovation in any manner. Accordingly, it is to be appreciated that alternative configurations exist which are to be included within this specification.

The top view 402 illustrates that the example housing has a substantially circular outward as well as inner diameter. Additionally, this view illustrates the hollow center aperture which permits the strand cable, rod, etc. to pass through the housing. In aspects, this center passageway can be most any appropriate diameter in order to accommodate a particular cable, rod, etc. In other words, the housing can be designed based upon a particular bracing or other application. Continuing with the top view, as shown, the reduced diameter section of the housing is shown. As described supra, this reduced diameter section facilitates mating with a cap component. While it has been described that the housing employs a reduced diameter section to mate with a cap, other aspects can employ an increased or substantially consistent diameter. In these alternative aspects, it will be understood that the cap component can accordingly be configured so as to communicatively mate with the housing component.

Referring now to a discussion of the front view 404, in this example, the housing component can employ a reduced diameter (and threaded) portion which is capable of communicatively mating with a cap. While specific dimensions, thread patterns, etc. are shown and discussed, it is to be appreciated that these are but examples and are not intended to limit the scope of the innovation in any manner.

As illustrated, the example housing is approximately 1.63 inches wide by 2.0 inches high. The reduced diameter portion (top) includes approximately 0.63 inches of threading. In one example, the threading is 1-⅜-12 UNF 2A thread pattern. The wider portion includes approximately 1.03 inches of a knurled band. This knurled surface can include a series of regular ridges or rectangles that assists in preventing slippage, for example, upon tightening. In one example, the knurl is 96 DP diamond knurl that completely bands the housing as shown.

The bottom view 406 illustrates an indicator that assists in the installation of the housing. For example, instructions such as “Insert Cable This End” can be scribed, raised from or printed upon the bottom face of the housing. These instructions assist an installer to properly insert the cable or rod. As will be understood, correct insertion is particularly important due to the functional gripping function of the internal wedges of the assembly.

The cross-sectional view 408 illustrates the tapered or flared shape of the internal portion of the housing. As will be understood, the internal shape of the housing enables the wedges to function, e.g., to retain the cable or rod. In one example, at the widest portion, the opening is approximately 1.018±0.015 inches. Similarly, at the smallest portion, the opening is approximately 0.5± inches.

In an example, the housing can be constructed of iron (e.g., 65-45-12 Ductile Iron) or other suitable material. Additionally, it is to be understood that other metals, alloys, composites and plastics can be employed in alternative aspects. In the Ductile Iron example, the housing can weigh approximately 0.674 pounds with an internal cavity volume of approximately 2.613 cubic inches.

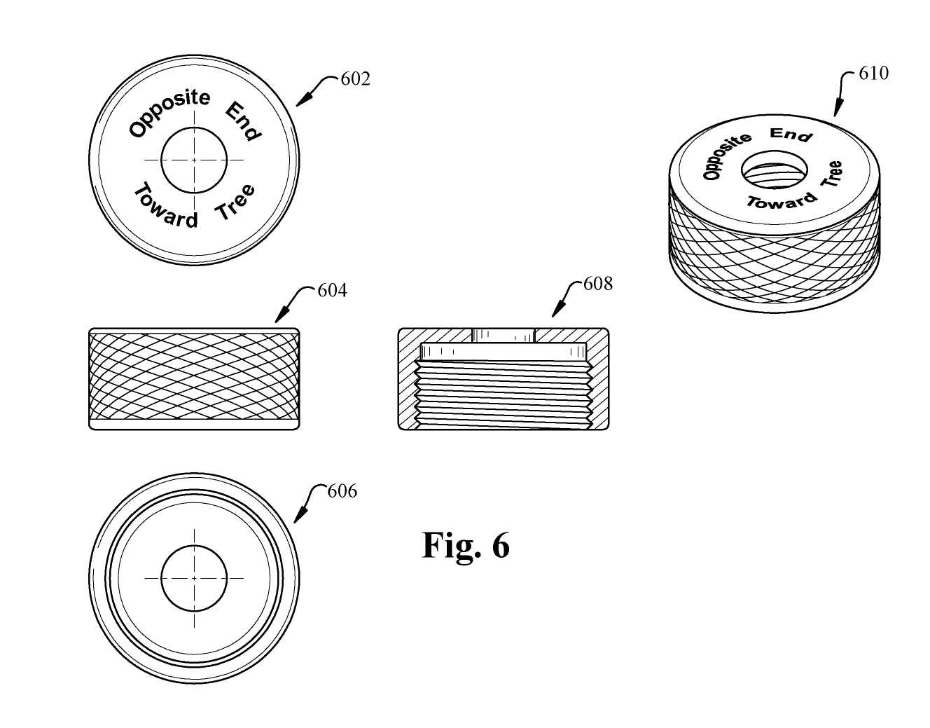

The perspective view 410 is included to illustrate the overall shape of the example housing. As discussed, the upper portion of the perspective view is capable of threading into a cap as will be discussed with reference to FIG. 6. While the examples described herein employ threaded connections between the housing and the cap, it is to be understood that other aspects exist that employ other means of communicatively coupling a housing to a cap. By way of example, and not limitation, pressure connectors, locking arrangements or the like can be employed to attach the housing to the cap.

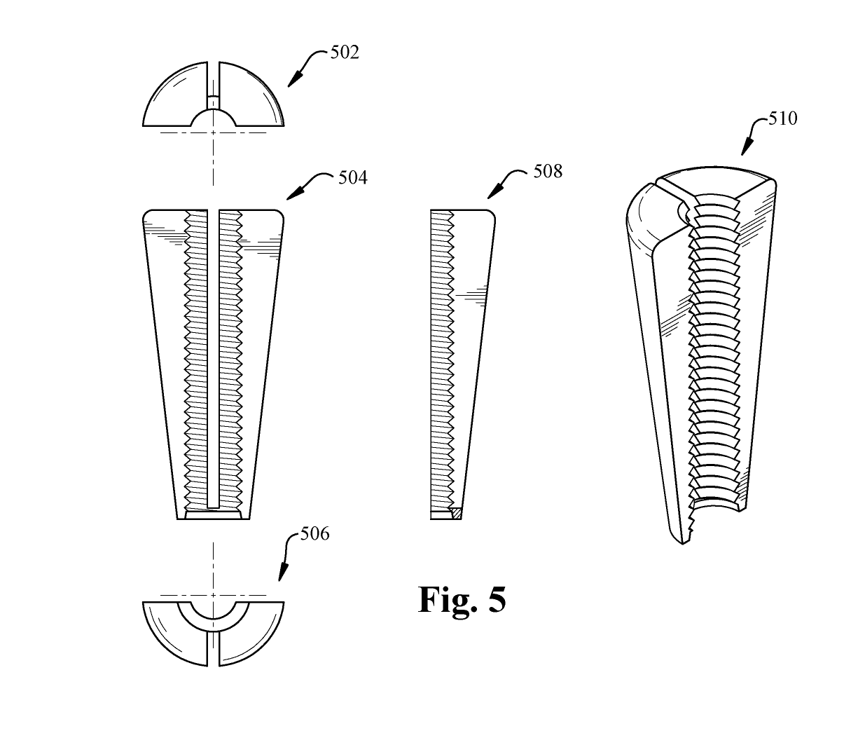

Referring now to FIG. 5, various views of a wedge insert or block (e.g., 202 of FIG. 2) are shown. In particularly, FIG. 5 illustrates a top view, a front view, a bottom view, a cross-sectional view and a perspective view. Each of these example views will be described below.

Referring first to the top view 502, as illustrated, the wedge can have a substantially semi-circular shape. The outer diameter of the wedge is slightly less than the inner diameter of the housing. In other words, the diameter of the wedge can gradually decrease from bottom to top (or vice-versa).

The front view 504 of the wedge illustrates the internal threading of the example wedge. While threading is employed to grip the cable or rod, it is to be understood that other aspects can employ other means of generating friction without departing from the spirit and/or scope of the innovation. For example, horizontal grooves could be used in other aspects. However, it will be understood that the manufacturing process of cutting threads is most often more efficient than cutting horizontal grooves. Nonetheless, the functionality of a rough surface can be established in multiple ways.

In the example, the overall length of the wedge is approximately 2.3 inches with a 0.09 inch groove cut along the centerline of the wedge. In an aspect that employs threads, it is to be understood that the thread dimensions can vary based upon a particular application. For instance, when the support strand has a ⅜ inch diameter, the thread dimension could be ⅜-16 UNC 2B. Similarly, when the support strand has a 5/16 inch diameter, the thread dimension could be 5/16-18 UNC 2B. Still further, for a support strand with a ¼ inch diameter, the thread dimension can be ¼-20 UNC 2B. In a last example, for a 3/16 inch strand diameter, the thread dimension can be 12-24 UNC 2B. It is to be understood that these examples are included to add context to the innovation and are not intended to limit the innovation in any manner.

The bottom view 506 is similar to the top view 502 in that it illustrates the semi-circle shape of the wedge. As will be understood, the diameter of the bottom and top of the wedge are consistent with the tapered shape as described herein.

The cross-sectional view 508 illustrates approximate dimensions of an example wedge. For instance, the top portion of the wedge can be approximately 6.5 inches±0.5 inch. The groove can have a depth of approximately 0.03 inches. The bottom dimension can have a width of 0.265±0.005 inches with a 45 degree rise as illustrated. The example wedge can be constructed of metal (e.g., 65-45-12 Ductile Iron) or other suitably rigid material. As appropriate, the wedge can be constructed of alternative metals, metal alloys, plastics, composites or the like. In the Ductile Iron example, the approximate weight of a wedge is approximately 0.0113 pounds, having a volume of approximately 0.399 cubic inches. This weight and volume correspond to an example wedge for use with a 3.8 inch strand. It will be understood that the dimensions will vary based upon disparate applications as well as materials.

FIG. 6 illustrates a top view, front view, bottom view, cross-sectional view and perspective view of an example cap in accordance with the innovation. As described supra, one feature of the cap is that it can assist in holding the assembly (e.g., 100 of FIG. 1) in place upon the strand (or rod) during installation. In operation, upon tightening the cap, the wedges are compressed around the bracing member (e.g., cable strand, rod) which, in effect, holds the assembly in place until cable tension is generated. Once cable tension is generated, the wedges seat and the assembly is locked onto the end of the strand.

The top view 602 of the cap illustrates that instructional text can be printed upon, scribed into, raised from, etc. the component. As shown, the text in this example instructs an installer “Opposite End Toward Tree” which identifies which end of the assembly faces the tree. This is particularly important in this example in order to maximize the use of the wedges. In an alternative aspect, hour-glass shaped wedges or alternating shaped wedge blocks can be employed such that the assembly can be as effective regardless of which end faces the tree (or stationary object). These alternative aspects are to be included within the scope of this disclosure and claims appended hereto.

The front view 604 of the cap illustrates that a knurled surface can be applied to reduce slippage upon tightening. For example, a 96 DP diamond knurl can be applied to the exterior band of the cap. The bottom view 606 illustrates the internal dimension of the component. It is to be appreciated that the cap can be equipped with threads capable of communicatively coupling to the housing component. In one aspect, these threads can be 1-⅜-12 UNF 2B as illustrated in cross-sectional view 608.

Moreover, the cap can be constructed of metal, for example 65-45-12 Ductile Iron. In this example, the cap will weigh approximately 0.182 pounds having a volume of approximately 0.705 cubic inches. It is to be understood that other metals, alloys, composites and plastics can be employed in alternative aspects as appropriate. The height of the cap can be approximately 0.81 inches with a threaded internal dimension of 0.57 inches. As described supra, these dimensions are but examples of a component. Accordingly, dimensions, materials, weights, etc. can vary based upon preference and/or application. The perspective view is illustrated to show the relative dimensions as well as the optional raised instructional lettering and knurls thereon.

Essentially, the innovation discloses an assembly that is capable of retaining a cable under tension through a stationary structure such as a tree. For example, when bracing two limbs of a forked-trunk tree, the limbs can be compressed inward (toward each other). Each of the limbs can be drilled to bore a hole completely through. A stranded cable (or other cable, rod, etc.) can be fed through both holes whereas a wedge assembly (e.g., 100 of FIG. 1) can be placed on either end of the outside of the limbs. The caps of each assembly can be hand (or wrench) tightened to secure the assembly upon the limb during installation. It will be understood that the tightening of the cap provides pressure of wedges upon the cable thereby retaining position upon the cable. Upon releasing the inward pressure upon the limbs, the internal wedges of the assembly will seat causing the assembly to hold into place.

It will be understood that this example installation is but one example implementation of the subject assembly. In other words, the assembly can be used in most any application where a cable, rod, rope, stranded cable, wire, etc. is under tension and it is desirable to stop the cable from pulling through a hole or structure, for example, a tree, pole, wall, plate, etc.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus that facilitates retention, comprising:
a housing having a cavity therein, wherein the housing accepts a length of material;
a wedge component that is positioned within the cavity of the housing, wherein the wedge component grips the length of material upon tension; and
a cap that communicatively mates with a reduced diameter end of the housing, wherein the cap generates pressure between the wedge component and the length of material.

2. The apparatus of claim 1, the length of material is a stranded cable.

3. The apparatus of claim 1, the length of material is an extruded rod.

4. The apparatus of claim 1, the housing and the cap are constructed of iron.

5. The apparatus of claim 1, the wedge component comprises at least two disparate wedge blocks.

6. The apparatus of claim 5, wherein each of the two disparate wedge blocks has a rough surface that contacts the length of material.

7. The apparatus of claim 6, wherein the rough surface is a set of spirally machined threads.

8. The apparatus of claim 5, wherein each of the wedge blocks has a groove cut along the length of a centerline of the rough surface, wherein the groove facilitates compression of the wedge block around the length of material.

9. The apparatus of claim 1, wherein the reduced diameter end of the housing employs threads to mate with the cap.

10. The apparatus of claim 1, wherein an exterior surface of the housing includes a band of knurled surface.

11. The apparatus of claim 1, wherein an exterior surface of the cap includes a band of knurled surface.

12. The apparatus of claim 1, wherein the cavity is tapered in shape to accommodate the wedge component.

13. The apparatus of claim 1, wherein the apparatus is employed to brace a wooded plant or tree.

14. The apparatus of claim 1, further comprising a tether assembly that connects the housing to the cap.

15. The apparatus of claim 1, further comprising a connection means positioned upon at least one of the cap or the housing, wherein the connection means facilitates at least one of a tether or support connection.

16. The apparatus of claim 15, wherein the connection means is at least one of a j-hook or an eye-bolt.

17. A method for retaining a length of material, comprising:
feeding an end of the length of material through a stationary structure and a wedge assembly, wherein an innermost end of the wedge assembly contacts the stationary structure;
terminating the end of the length of material at the outermost end of the wedge assembly; and
seating a plurality of wedges within the wedge assembly, wherein the seated plurality of wedges retain the length of material.

18. The method of claim 17, further comprising generating tension in the length of material, wherein the tension triggers the act of seating the plurality of wedges.

19. The method of claim 17, further comprising tightening a cap of the wedge assembly, wherein the act of tightening generates a nominal force that holds the wedge assembly upon the length of material.

20. The method of claim 17, wherein the length of material is at least one of a cable, wire, stranded cable, or rod.

21. A device that retains a cable in a tree bracing system, comprising:
means for positioning at least two wedge blocks around each end of the cable;
means for triggering seating of the at least two wedge blocks upon each of the ends of the cable; and
means for gripping the ends of the cable.

22. The device of claim 21, wherein the means for triggering seating of the at least two wedge blocks is cable tension.

23. The device of claim 21, wherein the means for gripping is a threaded groove pattern disposed upon the inner diameter of each of the at least two wedge blocks, wherein the groove pattern produces friction upon contact with the cable under tension.
